(19) United States
(12) Patent Application Publication
(10) Pub. No.: US 2009/0144711 A1
(43) Pub. Date: Jun. 4, 2009

(54) SYSTEM AND METHOD FOR COMMON COMPILER SERVICES BASED ON AN OPEN SERVICES GATEWAY INITIATIVE ARCHITECTURE

(75) Inventor: Chia-Jui Chang, Taipei (TW)

Correspondence Address: LADAS & PARRY, 5670 WILSHIRE BOULEVARD, SUITE 2100, LOS ANGELES, CA, 90036-5679, US

(73) Assignee: WISTRON CORPORATION, Taipei Hsien (TW)

(21) Appl. No.: 12/115,780

(22) Filed: May 6, 2008

(30) Foreign Application Priority Data
Nov. 29, 2007 (TW) 096145391

(51) Int. Cl. G06F 9/45

(52) U.S. Cl. 717/151

(57) ABSTRACT

A system and method for common compiler services based on an Open Services Gateway initiative (OSGi) architecture are constructed on an OSGi framework for processing and registering a server page source file. The method includes: transmitting a compilation request signal associated with the server page source file to a common compiler bridge interface unit; based on the compilation request signal, enabling the common compiler bridge interface unit to select a support compiler corresponding to the compilation request signal to compile the server page source file so as to obtain a server application file; and using a server application registration unit to complete registration of the server application file.

### CROSS-REFERENCE TO RELATED APPLICATION

This application claims priority of Taiwanese Application No. 096145391, filed on Nov. 29, 2007.

### BACKGROUND OF THE INVENTION

1. Field of the Invention

The invention relates to a system and method for providing compiler services, more particularly to a system and method for common compiler services based on an Open Service Gateway initiative architecture.

2. Description of the Related Art

With the vast development of the Internet, networks are no longer mere tools for assisting people at work. The facility and diverse information services provided by the Internet have been extended into almost every home.

However, computers with powerful functionality are too complicated for ordinary home users, who may wish to have a device that, aside from having Internet connection functionality, has a human-centered design, i.e., ease of use and clearly defined functions. Such requirements have spurred the development of digital home appliances. By installing a residential gateway (RG) in a living room, life at home can be digitalized. For example, a refrigerator can be connected to the Internet to download recipes, or a washing machine can be connected to a retailer via the Internet to request repair services in case of malfunctioning.

The spread of the concept of digital life also spurred the founding of the Open Service Gateway initiative (OSGi) Alliance in March 1999. The OSGi Alliance is a non-profit organization whose members specify an OSGi platform, aiming to establish an integrated information service platform for integration into the residential gateway. An OSGi architecture is schematically illustrated in FIG. 1.

The primary purpose of specifying the OSGi standard is to provide a solution for point-to-point service delivery between a remote software service provider and a local device, so that the remote software service provider can, depending on client requirements, dynamically deliver application programs or added value services to a residential gateway of a client for downloading through the Internet, and the downloaded programs or services can be automatically installed.

Among current web page application programs, JavaServer Pages (JSP) application offers various advantages: cross-platform compatibility, reusable components, separation of content generation from display, webpage development using tag libraries, multilayer enterprise application architecture, and rapid development of dynamic web pages. Thus, manufacturers in the field endeavor to develop JSP on the OSGi architecture 3. The version of Java Servlet supported by HTTP Service Specification defined in the current OSGi standard is mainly 2.1. However, this version cannot realize many of the functions provided by JSP that require at least Java Servlet 2.2. For example, different versions of the widely used webpage server Apache Tomcat require Java Servlet 2.2 or newer versions, as illustrated in a table 4 of the JSP versions and the respective Apache Tomcat versions shown in FIG. 2.

Accordingly, how to enable an OSGi framework-based HTTP service to support JSP is a major subject of endeavor in the concerned industrial sector. One currently available solution is to abandon the existing widely used webpage-related technical architectures and develop new modules, such as a new HTTP service module, a new HTTP (Java) Servlet module, and a new server registration module, and to integrate these new web solution modules into the OSGi framework.

However, there are three major drawbacks with the current solution:

1. Increased difficulty and costs of system development: Designing and developing a completely new specification for HTTP services not only entail increased difficulty, the time and money involved will also be considerable.

2. Weakened compatibility with other OSGi framework platforms: The HTTP service specification defined in the current OSGi Service Platform Service Compendium does not include the JSP specification or relevant development guidelines for later developers or maintainers to follow. Therefore, the current solution is merely to construct a new system to deal with individual problems. Although the dependency of the solution on the OSGi framework is enhanced, the cross-platform compatibility characteristic is considerably sacrificed.

3. Undesirable post-compile mechanism: In current relevant web solutions, compilation and registration of JSP files are triggered by a HTTP Servlet application module. Therefore, when a user accesses a JSP file for the first time, the HTTP server will request a JSP module to compile the JSP file via the HTTP server application module for subsequent registration so as to execute the JSP file. If there are errors in the JSP file, they will not be discovered until first accessed by a user. Such post-compile mechanism does not have the benefit associated with a pre-compile mechanism by which possible errors may be discovered and corrected during the web page development or deployment stage.

### SUMMARY OF THE INVENTION

Therefore, an object of the present invention is to provide a system for common compiler services based on an Open Services Gateway initiative architecture.

Accordingly, the system for common compiler services based on an Open Services Gateway initiative architecture of the present invention is constructed on an OSGi framework for processing and registering a server page source file. The system includes a compiler database, a common compiler bridge interface unit, and a server application registration unit. The compiler database includes a plurality of support compilers. The common compiler bridge interface unit receives a compilation request signal associated with the server page source file and, based on the compilation request signal, selects one of the support compilers corresponding to the compilation request signal from the compiler database to compile the server page source file so as to obtain a server application file. The server application registration unit is used to complete registration of the server application file.

Another object of the present invention is to provide a method for common compiler services based on an Open Services Gateway initiative architecture.

Accordingly, the method for common compiler services based on an Open Services Gateway initiative architecture of this invention is constructed on an OSGi framework for processing and registering a server page source file. The method includes the following steps: transmitting a compilation request signal associated with the server page source file to a common compiler bridge interface unit; based on the compilation request signal, enabling the common compiler bridge interface unit to select from a compiler database a support compiler corresponding to the compilation request signal to compile the server page source file so as to obtain a server application file; and using a server application registration unit of the OSGi framework to complete registration of the server application file.

A further object of the present invention is to provide another method for common compiler services based on an Open Services Gateway initiative architecture.

Accordingly, the method for common compiler services based on an Open Services Gateway initiative architecture of this invention includes the following steps: receiving a compilation request signal associated with a server page source file; based on the language type of the compilation request signal, compiling the server page source file so as to obtain a server application file; and based on the result of compiling the server page source file, determining whether registration of the server application file is to proceed.

The effect of this invention resides in that, instead of employing the current solution of developing an entirely new system dependent on the OSGi framework, the present invention provides common compiler services so that cross-platform compatibility can be maintained, and difficulty and costs associated with system development can be reduced.

### BRIEF DESCRIPTION OF THE DRAWINGS

Other features and advantages of the present invention will become apparent in the following detailed description of the preferred embodiment with reference to the accompanying drawings, of which:

FIG. 1 schematically illustrates an OSGi architecture;

FIG. 2 illustrates a table of Apache Tomcat server versions vs. Servlet/JSP specifications;

FIG. 3 is a block diagram to illustrate a preferred embodiment of a system for common compiler services based on an Open Services Gateway initiative architecture according to the present invention; and

FIG. 4 is a flowchart to illustrate a method for the system of the preferred embodiment.

### DETAILED DESCRIPTION OF THE PREFERRED EMBODIMENT

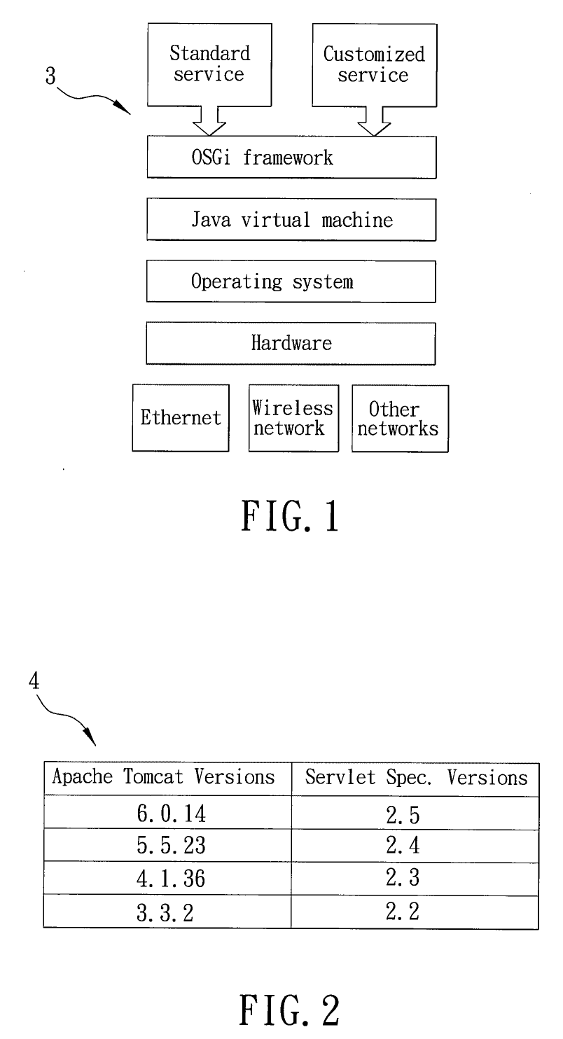

Before the present invention is described in greater detail, the Open Services Gateway initiative (hereinafter OSGi) architecture 3 is briefly discussed. The OSGi architecture 3 is primarily composed of three elements: framework, bundle and service. A framework is constructed on a Java virtual machine, as shown in FIG. 1. A bundle executes an application program on the framework. A service is interface service exported or imported by the bundle. Thus, a bundle downloaded from a remote server will automatically install and execute on the OSGi framework, and will register with the OSGi platform the services exported for sharing or imported by the bundle.

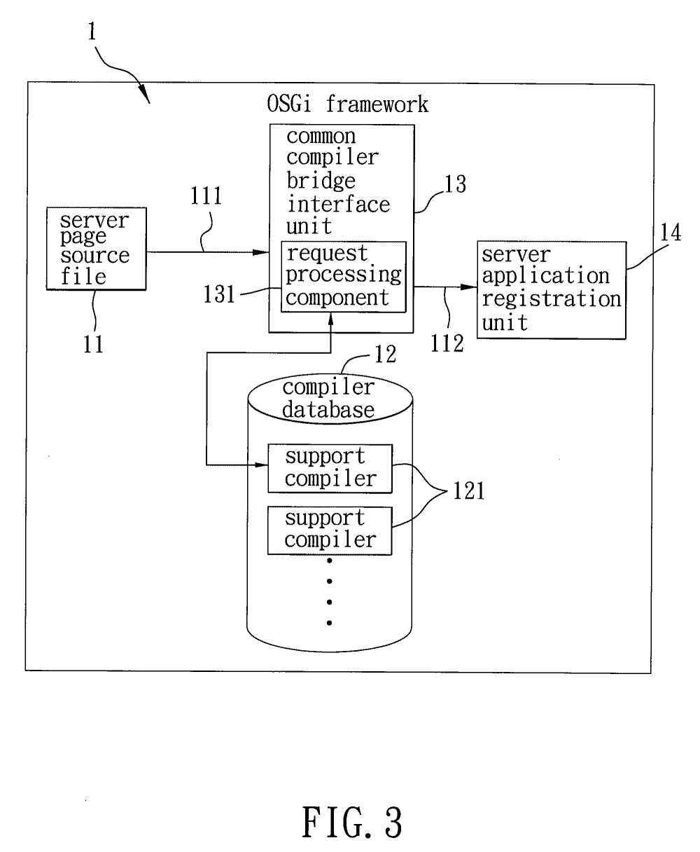

Referring to FIG. 3, the preferred embodiment of a system for common compiler services based on an Open Services Gateway initiative (OSGi) architecture according to the present invention is constructed on an OSGi framework 1 for processing and registering a server page source file 11. The system includes a compiler database 12, a common compiler bridge interface unit 13 including a request processing component 131, and a server application registration unit 14.

It is noted that, in this preferred embodiment, the relevant units or components mentioned hereinabove are exemplified in the context of Java 2 Standard Edition (J2SE) offered by Sun Microsystems. Accordingly, the common compiler bridge interface unit 13 and the server application registration unit 14 are, respectively, Java Archive (JAR) files. A Java Archive file includes Java classes with special functions and developed in response to demands, activator classes requisite for executing Java applications, a manifest header related to Java language operation flow, and some source files (such as embedded html, image files, etc.). Since the Java Archive file includes Java classes, the Java classes can be dynamically loaded into a memory of a client computer via a Java Loader, and can be executed after going through a Java byte code verifier and an interpreter. The server page source file 11 is a JavaServer Pages (JSP) file. In addition, the request processing component 131 is a Java class.

The compiler database 12 provides a plurality of support compilers 121 capable of compiling various programming languages, such as JSP and Active Server Pages (ASP), so as to be able to compile languages other than JSP.

The common compiler bridge interface unit 13 is used to receive a compilation request signal 111 associated with the server page source file 11, and utilizes the request processing component 131 to select one of the support compilers 121 corresponding to the compilation request signal 111 from the compiler database 12 based on the compilation request signal 111 to compile the server page source file 11 so as to obtain a server application file (not shown).

It is noted that, in this preferred embodiment, the system for common compiler services based on an Open Services Gateway initiative (OSGi) architecture may further include an information storage component (not shown), which, prior to receipt of the compilation request signal 111 by the request processing component 131, receives the compilation request signal 111 and rearranges content of the signal into a format suitable for processing by the request processing component 131 for subsequent storage into the information storage component. Therefore, the information storage component is a data structure for storing information contained in the compilation request signal 111.

The server application registration unit 14 is used to complete registration of the server application file.

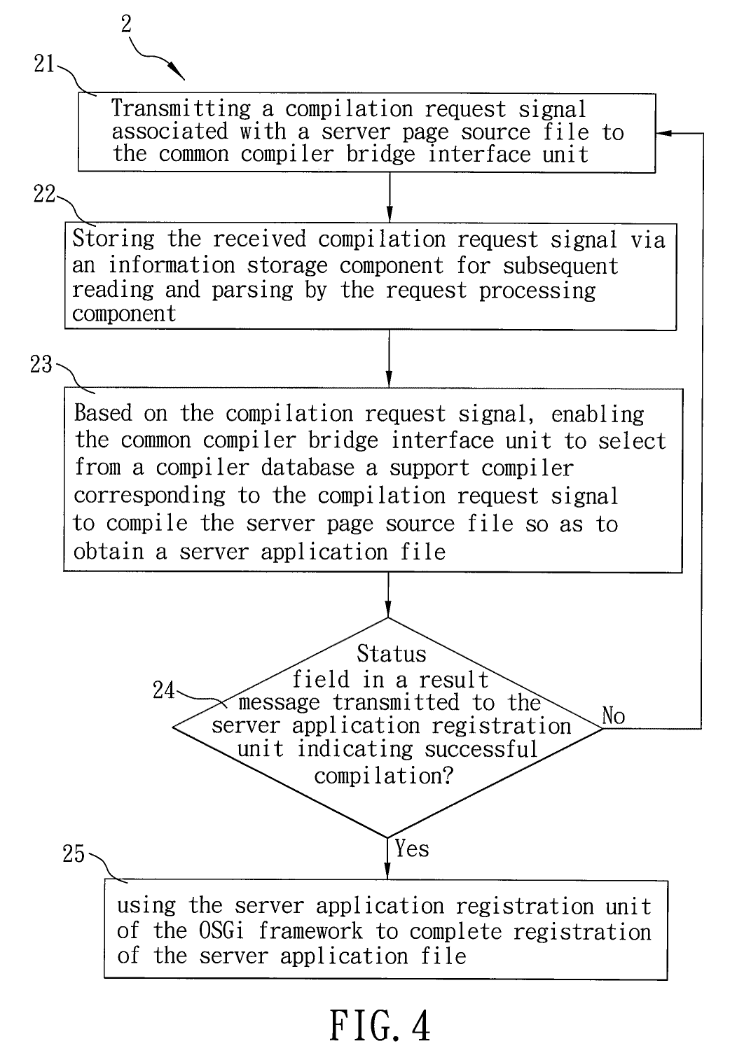

Referring to FIGS. 3 and 4, a method for the system of the preferred embodiment according to the present invention is constructed on the OSGi framework 1 to process and register a server page source file 11, and includes the following steps:

In step 21, a compilation request signal 111 associated with the server page source file 11 is transmitted to the common compiler bridge interface unit 13.

In step 22, the received compilation request signal 111 is stored via an information storage component (not shown), and is read by the request processing component 131 for parsing.

In step 23, based on the compilation request signal 111, the common compiler bridge interface unit 13 selects a support compiler 121 corresponding to the compilation request signal 111 from the compiler database 12 to compile the server page source file 11 so as to obtain a server application file (not shown).

Specifically, in steps 21, 22 and 23 of this embodiment, when a JSP file sends out a compilation request signal 111, the content of the compilation request signal 111 is rearranged and stored via the information storage component (not shown), and the content of the received compilation request signal 111 is read by the request processing component 131 from the information storage component (not shown). Furthermore, after determining the language type of the compilation request signal 111, which is the JSP language in this example, the server page source file 111 is passed on to the JSP compiler selected from the compiler database 12 for compilation. Furthermore, a Java-related server application file is generated after compilation.

After step 23, step 24 is executed in which a result message 112 including a status field (not shown) is transmitted to the server application registration unit 14. If the status field in the result message 112 indicates successful compilation, subsequent steps are executed.

Based on the foregoing, in a J2SE technical environment, when the request processing component 131 calls the JSP compiler to compile the JSP file, if a compilation error occurs, a parameter indicating failure, such as “0” or other characters used to indicate failure, is entered into the status field. If compilation is successful, a parameter indicating success, such as “1” or other characters used to indicate success, is entered into the status field. Furthermore, after the parameter indicating failure or success is entered, the result message 112 is transmitted to the server application registration unit 14. If the parameter in the status field in the result message 112 is indicative of successful compilation, the flow goes to step 25. If the parameter in the status field in the result message 112 is indicative of failed compilation, registration of the server application file is terminated to await transmission of a next compilation request signal 111 to the common compiler bridge interface unit 13.

In step 25, the server application registration unit 14 of the OSGi framework 1 is used to complete registration of the server application file.

Specifically, for the J2SE technical environment, step 25 is to conduct subsequent processing of a Java Servlet file as compiled by the JSP compiler and to complete registration thereof, e.g., using a loader of a Java class to generate a class object corresponding to the Java Servlet file, and to further provide an interface and method for registration through an HTTP wrapper class so as to complete subsequent registration of the class object of the Java Servlet file, thereby deploying a legal and usable web page. Since the Java class loader and the wrapper class are known to persons familiar with the Java language, they will not be discussed in greater detail herein for the sake of brevity.

In sum, the system and method for common compiler services based on an Open Services Gateway initiative (OSGi) architecture according to the present invention have the following advantages:

1. Ease of system development and reduced development costs: This invention provides compiler services on the OSGi framework by separating the desired compiler (such as the JSP compiler in the above example) from the architecture and by packaging the same into a compiler application interface (compiler API), without requiring overall changes for the existing architecture. Therefore, compared to current solutions, the difficulty, as well as time and costs, associated with system development may be considerably reduced.

2. Maintaining the cross-platform compatibility of the OSGi platform: The present invention provides JSP compiler services without the need to change default non-JSP supported HTTP services provided by the current OSGi framework and the server application registration. In addition, developing the necessary related compiler application interface (i.e., the common compiler bridge interface unit 13 in this embodiment) is far simpler than the current solutions, and the various services defined by the current OSGi specifications are easier to use. Therefore, the problem of reduced cross-platform compatibility associated with complicated system development can be overcome.

3. Pre-compile mechanism: With the present invention, there is no need to change the program and flow of the current OSGi-compatible Java Servlet application. A JSP file can be compiled prior to registration of the JSP file by calling a JSP compiler in the compiler database 12 through the request processing component 131 of the compiler bridge interface unit 13 of this embodiment to perform compilation, that is the pre-compile mechanism known in the art of programming language. Thus, any compilation error can be easily discovered and rectified during the process of system development, thereby eliminating the drawback associated with current solutions in which compilation errors are discovered only when the user first accesses the JSP file.

4. Expandability: By providing the compiler database 12 containing a plurality of support compilers 121 in the OSGi framework 1, compilation of various programming languages can be supported. In addition, the support compilers 121 may be removed from or added to the compiler database 12 to provide various compilation services for different programming languages.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A system for common compiler services based on an Open Services Gateway initiative architecture, said system comprising:
a compiler database having a plurality of support compilers;
a common compiler bridge interface unit for receiving a compilation request signal associated with a server page source file and for selecting one of the support compilers corresponding to the compilation request signal from said compiler database based on the compilation request signal to compile the server page source file so as to obtain a server application file; and
a server application registration unit for completing registration of the server application file.

2. The system for common compiler services based on an Open Services Gateway initiative architecture according to claim 1, wherein said common compiler bridge interface unit includes a request processing component for reading the compilation request signal and for selecting said one of the support compilers corresponding to the compilation request signal to compile the server page source file.

3. The system for common compiler services based on an Open Services Gateway initiative architecture according to claim 2, wherein the server page source file is a JavaServer Pages (JSP) file, and said compiler database includes a JSP compiler, each of said common compiler bridge interface unit and said server application registration unit being a Java Archive file.

4. The system for common compiler services based on an Open Services Gateway initiative architecture according to claim 2, wherein said server application registration unit receives a result message transmitted from said common compiler bridge interface unit so as to perform registration of the server application file.

5. A method for common compiler services based on an Open Services Gateway initiative (OSGi) architecture, said method being constructed on an OSGi framework for processing and registering a server page source file, and including the following steps:
transmitting a compilation request signal associated with the server page source file to a common compiler bridge interface unit;
based on the compilation request signal, enabling the common compiler bridge interface unit to select from a compiler database a support compiler corresponding to the compilation request signal to compile the server page source file so as to obtain a server application file; and
using a server application registration unit of the OSGi framework to complete registration of the server application file.

6. The method for common compiler services based on an Open Services Gateway initiative architecture according to claim 5, further comprising: transmitting a result message to the server application registration unit to enable the server application registration unit to determine whether registration of the server application file is to be performed.

7. The method for common compiler services based on an Open Services Gateway initiative architecture according to claim 6, wherein the result message includes a status field, registration of the server application file being performed if the status field in the result message is indicative of successful compilation.

8. The method for common compiler services based on an Open Services Gateway initiative architecture according to claim 5, wherein the common compiler bridge interface unit includes a request processing component for reading the compilation request signal and for selecting the support compiler corresponding to the compilation request signal to compile the server page source file.

9. The method for common compiler services based on an Open Services Gateway initiative architecture according to claim 8, further comprising: storing the received compilation request signal in an information storage component for subsequent reading and parsing by the request processing component.

10. The method for common compiler services based on an Open Services Gateway initiative architecture according to claim 5, wherein the server page source file is a JavaServer Pages file, the compiler database including a JavaServer Pages compiler, each of the common compiler bridge interface unit and the server application registration unit being a Java Archive file.

11. A method for common compiler services based on an Open Services Gateway initiative architecture, said method comprising the following steps:
receiving a compilation request signal associated with a server page source file;
based on the language type of the compilation request signal, compiling the server page source file so as to obtain a server application file; and
based on the result of compiling the server page source file, determining whether registration of the server application file is to be performed.

12. The method for common compiler services based on an Open Services Gateway initiative architecture according to claim 11, wherein compiling the server page source file includes selecting a support compiler corresponding to the language type of the compilation request signal to compile the server page source file.

13. The method for common compiler services based on an Open Services Gateway initiative architecture according to claim 11, wherein, if compilation of the server page source file is successful, a result message indicating successful compilation is sent to a server application registration unit for performing registration of the server application file.

14. The method for common compiler services based on an Open Services Gateway initiative architecture according to claim 13, wherein the result message includes a status field, the status field having a parameter indicating successful compilation.

15. The method for common compiler services based on an Open Services Gateway initiative architecture according to claim 13, wherein, if compilation of the server page source file is unsuccessful, a result message indicating failed compilation is sent to the server application registration unit to terminate registration of the server application file.

16. The method for common compiler services based on an Open Services Gateway initiative architecture according to claim 15, wherein the result message includes a status field, the status field having a parameter indicating failed compilation.
